(19) United States
(12) Patent Application Publication
(10) Pub. No.: US 2015/0257539 A1
(43) Pub. Date: Sep. 17, 2015

(54) Two-part computer keyboard with office chair

(71) Applicant: Alexander Drake, Chelsea, MA (US)

(72) Inventor: Alexander Drake, Chelsea, MA (US)

(21) Appl. No.: 14/208,420

(22) Filed: Mar. 13, 2014

(51) Int. Cl. A47C 7/72; G06F 3/02

(52) U.S. Cl. CPC A47C 7/72; G06F 3/0219

(57) ABSTRACT

A two-part computer keyboard with office chair features keys separated into two keyboard halves for the right and left hands. The two separate components are preferably wireless and battery-powered, and may be temporarily affixed to office chair armrests, optionally with a mousing surface or alternate pointing device located laterally on the side of the user's dominant hand. An office chair, designed for use with the two-part keyboard and enabling the user to independently rotate and revolve the articulated armrests, is available and may be purchased separately, or with the two-part keyboard as a kit.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to computer components and accessories, and in particular to a two-part computer keyboard with office chair. Carpal tunnel syndrome is only the most well-known of a family of repetitive motion injuries, which have become the bane of workman's compensation insurance adjusters across the country. The search is on for office furnishings and accessories which will prevent these injuries. An ergonomic keyboard, featuring a one-piece keyboard with the key array divided into two halves positioned at an obtuse angle with each other, appeared in the 1990s but did not gain broad acceptance. The problem addressed by the ergonomic keyboard was the unnatural position of the typist's hands and arms when using a conventional keyboard, which contributes substantially to repetitive motion injuries. By taking the concept of the ergonomic keyboard several steps farther, the problem can be solved. The keyboard is divided into two separate components, and mounted on the arms of an office chair. The arms of the chair may be separately rotated and revolved by the typist to whatever angles are comfortable, addressing the source of many repetitive motion injuries. The two-part computer keyboard with office chair solves these problems.

U.S. Pat. No. 5,612,718, issued Mar. 18, 1997 to Bryan (hereinafter “Bryan”) discloses an office chair with integral split keyboards. Bryan, however, is subject to several significant shortcomings. Bryan teaches an overly complex and expensive office chair structure from which the keyboards are inseparable. Moreover, Bryan teaches no dedicated integral surface for supporting a pointing device of the user's choice (e.g., mouse, touchpad, track ball, etc.), and instead indicates a track ball, which may be internal to the keyboard structure or an external track ball to be placed on a provided integral surface that is not pivotable relative to the arm rest. Additionally, Bryan teaches the keyboard halves being fixed to the arm rest such that it pivots in the horizontal plane only about its own center, and not about the pivot of the user's wrist, forcing the user to rely upon the provided pivoting armrest. These and other drawbacks are addressed by the extensibility of the invention disclosed herein.

### SUMMARY OF THE INVENTION

Accordingly, the invention is directed to a two-part computer keyboard with office chair. The keys are separated into two keyboard halves for the right and left hands. The two separate components are preferably wireless and battery-powered, and may be temporarily affixed to office chair armrests, optionally with a mousing surface or alternate pointing device located laterally on the side of the user's dominant hand. An office chair, designed for use with the two-part keyboard and enabling the user to independently rotate and revolve the articulated armrests, is available and may be purchased separately, or with the two-part keyboard as a kit.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 is a side view of the first exemplary embodiment, mounted on an office chair, displaying the right keyboard half 10B, the chair 12, the armrest 13, the turntable 15, and the padded C-Clamp 16.

FIG. 2 is a front view of the first exemplary embodiment, mounted on an office chair, displaying the keyboard halves 10, the left keyboard half 10A, the right keyboard half 10B, the mousing surface 11, the chair 12, the armrest 13, the bracket 14, the padded turntables 15, and the padded C-clamps 16.

FIG. 3 is a top view of the first exemplary embodiment with the right keyboard half rotated outward, displaying the keyboard halves 10, the left keyboard half 10A, the right keyboard half 10B, and the mousing surface 11.

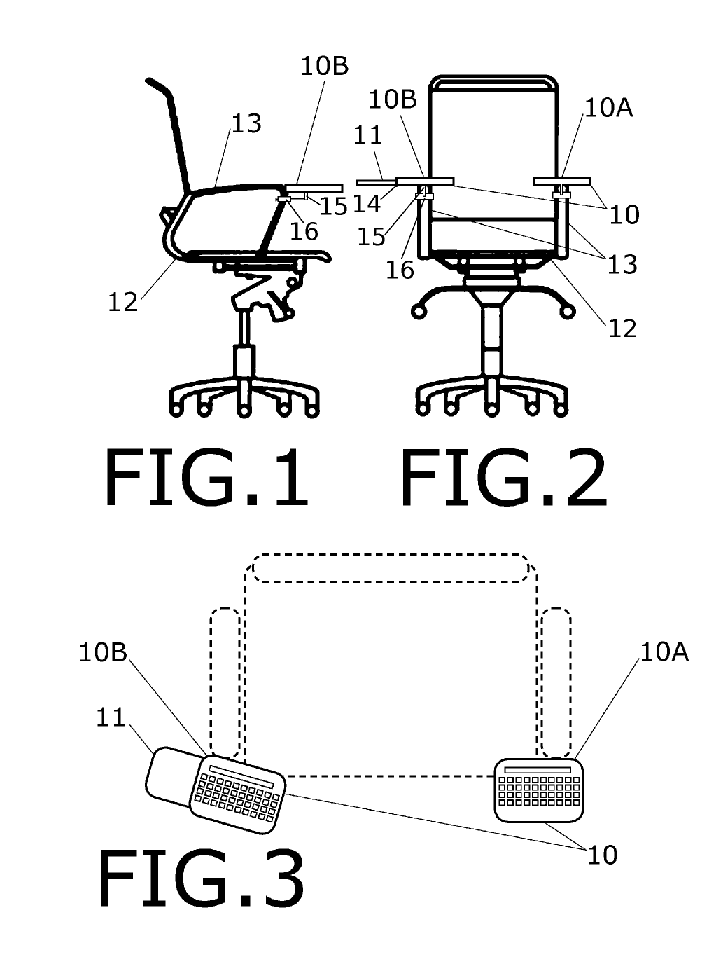

### DETAILED DESCRIPTION OF THE INVENTION

Referring now to the invention in more detail, the invention is directed to a two-part computer keyboard with office chair. The keys are separated into two keyboard halves 10 for the right and left hands. The two separate components are preferably wireless and battery-powered, and may be temporarily affixed to the armrests 13 of an office chair 12, optionally with a mousing surface 11 or alternate pointing device located laterally on the side of the user's dominant hand. An office chair 12, designed for use with the two-part keyboard and enabling the user to independently rotate and revolve the articulated armrests, is available and may be purchased separately, or with the two-part keyboard as a kit.

The first exemplary embodiment may be summarized as a kit for retrofitting an existing, off-the-shelf, or otherwise not purpose-built office chair with arms and comprises two keyboard halves 10: the left keyboard half 10A, and the right keyboard half 10B. A pair of small padded C-clamps 16 is affixed permanently to the bottom surface of a small turntable 15, which in turn is mounted on the bottom surface of each keyboard half 10. The C-clamps 16 enable the user to mount each keyboard half 10 securely to the outer end of the armrest 13 of an office chair 12, or another type of chair such as a wheelchair, without scratching or otherwise damaging the armrest 13. The turntable 15 enables the user to turn the keyboard half 10 relative to the armrest 13 with rotation about a point approximately below the expected position of the user's wrist pivot point.

Mounting brackets 14 on the lateral surface of each keyboard half 10 enables the user to attach a mousing surface 11, which is provided, to the keyboard half 10 which is used by the user's dominant hand. Thus, if the user is right-handed, the mousing surface 11 should be attached to the lateral surface of the right keyboard half 10B.

Each keyboard half 10 is preferably wireless and battery-powered. The electronic components of each keyboard half 10 preferably include one or more replaceable batteries, and a radio frequency (RF) transmitter or other short-range wireless transmitter, for example a transmitter and receiver conforming to the popular Bluetooth wireless protocol. The keyboard halves 10 are configured to operate as a single logical keyboard input to a computer workstation or other computing device. Alternate embodiments, featuring a trackball or other cursor manipulation device to replace the mousing surface 11, are contemplated.

The second exemplary embodiment may be summarized as a purpose-built chair incorporating the invention and features the keyboard halves 10 and the mousing surface 11, with a specialized reclining office chair 12 which is designed for use with the two-part keyboard. The armrests 13 are articulated beneath the user's elbows, enabling the user to horizontally rotate each armrest 13, and vertically revolve each armrest 13, independently from the other armrest 13 and from the back and seat of the office chair 12.

The user's wrists may be secured to and supported by the armrests 13 with removable wrist devices which are provided, such as padded hooks, stirrups, or nylon straps with hook-and-loop fasteners. When used in conjunction with an articulated mount for a computer monitor or laptop, the two-part keyboard and the office chair 12 enable the user to operate all features of a desktop or laptop computer from a reclined position. Thus the user may be severely disabled or recovering from a severe injury or illness, and remain fully productive. The wrist devices are such that the user may easily and immediately gain release from them without assistance.

An alternate embodiment, wherein the armrests 13 of the office chair 12 are more fully articulated from ball joints beneath and behind the user's armpits, and each armrest 13 provides a more complete carriage or cradle for the user's arm, is also contemplated.

To use the first and second exemplary embodiments, the user affixes the left keyboard half 10A to the armrest 13 on the left side of the office chair 12, and the right keyboard half 10B to the armrest 13 on the right side of the office chair 12, using the C-clamps. The user then attaches the mousing surface 11 to the lateral side surface of the keyboard half 10 which will be used by the dominant hand, using the mounting brackets. The user may then sit in the office chair 12 and, if using the second exemplary embodiment, may optionally secure the wrists to the armrests 13 using the wrist devices.

The keyboards 10 and the mousing surface 11 are preferably manufactured from a rigid, durable material such as plastic. The office chair 12 and the armrests 13 are preferably manufactured from rigid, durable materials such as steel, aluminum alloy, and high-impact plastic, featuring padding which is preferably manufactured from a flexible, durable material such as foam rubber, covered by a flexible, durable fabric such as cotton, nylon, or a cotton-polyester blend. The wrist devices, if provided in the form of padded hooks, are preferably manufactured from rigid, durable materials such as steel, aluminum alloy, and high-impact plastic, featuring padding which is preferably manufactured from a flexible, durable material such as foam rubber or silicone. If provided in the form of stirrups or straps with hook-and-loop fasteners, the wrist devices are preferably manufactured from a flexible, durable material, such as leather or nylon webbing. Components, component sizes, and materials listed above are preferable, but artisans will recognize that alternate components and materials could be selected without alter

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A divided keyboard and office chair system comprising:
(a) a keyboard;
(b) said keyboard being divided into a left keyboard half and a right keyboard half;
(c) said left keyboard half and said right keyboard half being in electronic communication with each other and with a computing device to which said left keyboard half and said right keyboard half are configured to appear as a single logical keyboard;
(d) said left keyboard half and said right keyboard half each being rotatably mounted atop one of a pair of turntables;
(e) an office chair;
(f) said office chair having a left armrest and a right armrest;
(g) each of said pair of turntables being affixed to one of said left arm rest or said right arm rest such that said left keyboard half is mounted, via one of said pair of turntables, to said left arm rest, and such that said right keyboard half is mounted, via one of said pair of turntables, to said right arm rest, such that each of said turntables rotates about a point about underneath the expected position of a user's wrist pivot point.

2. The divided keyboard and office chair system of claim 1 further comprising a pair of padded C-clamps, each of said pair of turntables being removably affixed to one of said left arm rest or said right arm rest via one of said padded C-Clamps.

3. The divided keyboard and office Chair system of claim 2 wherein said office chair is any of the group of existing, off-the-shelf, or not purpose-built.

4. The divided keyboard and office chair system of claim 1 further comprising a mousing surface and a bracket, said mousing surface being selectively attachable, via said bracket, to the lateral edge of either said left keyboard half or said right keyboard half.

5. The divided keyboard and office chair system of claim 2 further comprising a mousing surface and a bracket, said mousing surface being selectively attachable, via said bracket, to the lateral edge of either said left keyboard half or said right keyboard half.

6. The divided keyboard and office chair system of claim 3 further comprising a mousing surface and a bracket, said mousing surface being selectively attachable, via said bracket, to the lateral edge of either said left keyboard half or said right keyboard half.

7. The divided keyboard and office chair system of claim 1 wherein said office chair is purpose-built, and wherein each of said pair of turntables is directly and non-removably affixed to one of said left arm rest or said right arm rest.

8. The divided keyboard and office chair system of claim 7 further comprising a mousing surface and a bracket, said mousing surface being selectively attachable, via said bracket, to the lateral edge of either said left keyboard half or said right keyboard half.

9. The divided keyboard and office chair system of claim 7 wherein said office chair, said left arm rest, and said right arm rest incorporate one or more ergonomic features selected from the group of articulating elbows, reclining back, horizontal arm rest rotation, vertical arm rest rotation, securing means for securing a user's wrist to said left arm rest or said right arm rest, or support means for supporting a monitor or laptop computer.

10. The divided keyboard and office chair system of claim 8 wherein said office chair, said left arm rest, and said right arm rest incorporate one or more ergonomic features selected from the group of articulating elbows, reclining back, horizontal arm rest rotation, vertical arm rest rotation, securing means for securing a user's wrist to said left arm rest or said right arm rest, or support means for supporting a monitor or laptop computer.
